(19) United States
(12) Patent Application Publication
(10) Pub. No.: US 2003/0080643 A1
(43) Pub. Date: May 1, 2003

(54) Brushless rotating electric machine

(75) Inventor: Shin Kusase, Obu-city (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 10/214,320

(22) Filed: Aug. 8, 2002

(30) Foreign Application Priority Data
Oct. 26, 2001 (JP) 2001-329849

(51) Int. Cl. H02K 3/00

(52) U.S. Cl. 310/179

(57) ABSTRACT

A brushless rotating electric machine has an armature with a polyphase winding on an armature core, a field core wound with a field winding, a first exciting means which provides flux variation to the field core and a second exciting means which supplies direct current to the field winding by utilizing the flux variation provided as an exciting source to the field core by the first exciting means. The machine may also provide a structure so that the first exciting means is an excitation winding wound on the armature core to supply direct current, and the second exciting means has an induction winding provided on the field core and a rectifier connected to the induction winding. Additionally, the electric machine can be constructed so that the induction winding serves also as the field winding and short-circuits the field winding through the rectifier.

### CROSS REFERENCE TO RELATED APPLICATION

This application is based upon, claims the benefit of priority of, and incorporates by reference the contents of prior Japanese Patent Application No. 2001-329849 filed Oct. 26, 2001.

### BACKGROUND OF THE INVENTION

1. Field of the Invention

The present invention relates to a rotating electric machine applicable to various uses, for instance, on a vehicle, and particularly to a maintenance-free rotating electric machine suitable for long-time operation.

2. Description of Related Art

A rotating electric machine for a wind-powered system to be used in a high-altitude mountainous district is demanded to be usable for extended periods of time under an especially low-humidity operating condition. It is impossible, under such harsh environments, to use brushes in general use for supplying the electric current to the field winding of a rotor. Therefore, in the case of a generator, for example, a Landelle brushless generator which is referred to as a four-gap type generator is commonly used. This brushless generator is constructed such that the field winding and the field core are partly secured to the housing, so that the excitation current can be supplied to the field winding without using brushes.

While the generator provided with brushes has two air gaps in the loop of the main magnetic flux, the conventional brushless generator stated above is provided with four air gaps. However, a problem arises relating to a decrease in output.

In a brushless generator in which the number of air gaps is not increased, the use of a generator with a permanent magnet or an inductor is conceivable. However, when the permanent magnet is adopted, the exciting power will be fixed, creating on the output side the on-off control of regulation, the amount of electric power generated. To perform the above-described on and off control, therefore, it is necessary to use transistors and thyristors to constitute the control mechanism, which will result in increased costs. Also in the case of the generator provided with the inductor, it is necessary to supply the phase-advance current to the armature, which, therefore, will need such an expensive device as an inverter circuit, further raising the problem that the constitution of the device will become so complicated as to deteriorate its reliability.

### SUMMARY OF THE INVENTION

In view of the above-described limitations in the known devices, it is an object of the present invention to provide a brushless rotating electric machine that features very little decrease in output and is capable of being produced at a lower cost compared to previous devices.

To overcome the above-described limitations, the brushless rotating electric machine of this invention has an armature with a polyphase winding wound on an armature core, a field core on which a field winding is wound, a first exciting means which provides magnetic flux variation to the field core, and a second exciting means which supplies the direct current to the field winding by utilizing, as a source of excitation, the magnetic flux variation given to the field core from the first exciting means. Thus the electric power is produced on the field side through the first generating operation when a slight magnetic flux is provided from the first exciting means to the field core. The magnetic field is excited by the electric power thus produced, subsequently generating electric power by the second generating operation at the armature.

That is, the amplification performance is enhanced by performing two stages of generation, thereby enabling the gain of a great amount of electric power. The excitation power is supplied by the electromagnetic induction of the first exciting means to the second exciting means provided on the field core side. The brushless rotating electric machine of this invention, unlike conventional machines, requires no current supply through the brushes, and therefore it is possible to adopt a two-gap type magnetic circuit, which can prevent output lowering.

It is desirable that the first exciting means stated above be a magnetizing winding wound on the armature core supplied with the direct current and that the second exciting means include an induction winding wound on the field core with a rectifier connected to this induction winding. It is possible to realize a brushless construction simply by the provision of the induction winding and the rectifier on the field core side and the magnetizing winding on the armature core side. Therefore neither an expensive component nor a complicated control mechanism is needed, enabling a cost reduction. Furthermore, the amount of excitation current can be adjusted by the second exciting means by adjusting the amount of the electric current to be supplied to the magnetizing winding, thus allowing easy control of the output voltage and the amount of electric power generated.

The induction winding stated above serves also as a field winding, which therefore is desired to be short-circuited through a rectifier, to thereby make it possible to decrease the number of components on the field core side for the purpose of cost reduction. This type of induction winding just needs the addition of the rectifier for short-circuiting the field winding, enabling easy design and improvement in reliability as compared with the conventional brush construction.

Furthermore the armature winding and the magnetizing winding stated above are desired to be wound with the same pitch in a plurality of slots formed in the armature core. Using the magnetizing winding wound with the same pitch as the armature winding can efficiently form the source of excitation necessary for supplying the direct current by the second exciting means in accordance with the pole pitch of the magnetic field.

The number of series conductors of the above-described magnetizing winding is desired to be less than the number of series conductors of the polyphase winding. When the magnetizing winding, wound on the armature core with the same pitch as the armature winding, is actually adopted, there is generated an induction voltage in the magnetizing winding with the rotation of the magnetic field. In this case, the induction voltage of the magnetizing winding can constantly be kept lower than that of the armature winding, making it possible to easily control the supply of the electric current to the magnetizing winding. Also it is desirable that the above-described magnetizing winding be constructed by the use of a part of the armature winding, which enables cost reduction because of a decrease in component count and installation time.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a view showing the basic construction of one embodiment of a brushless generator;

FIG. 2 is an explanatory view of a rotor;

FIG. 3 is an explanatory view of an armature;

FIG. 4 is an explanatory view showing details of an armature winding;

FIG. 5 is a connection diagram of a brushless generator of the present embodiment;

FIG. 6 is an explanatory view of a rotor included in the second embodiment of the brushless generator;

FIG. 7 is an explanatory view of an armature; and

FIG. 8 is a cross-sectional view showing the construction of a Landelle rotor.

### DESCRIPTION OF THE PREFERRED EMBODIMENTS

The following description of the preferred embodiments is merely exemplary in nature and is in no way intended to limit the invention, its application, or uses. One embodiment of a brushless generator of this invention will be explained in detail with reference to the accompanying drawings.

[First Embodiment]

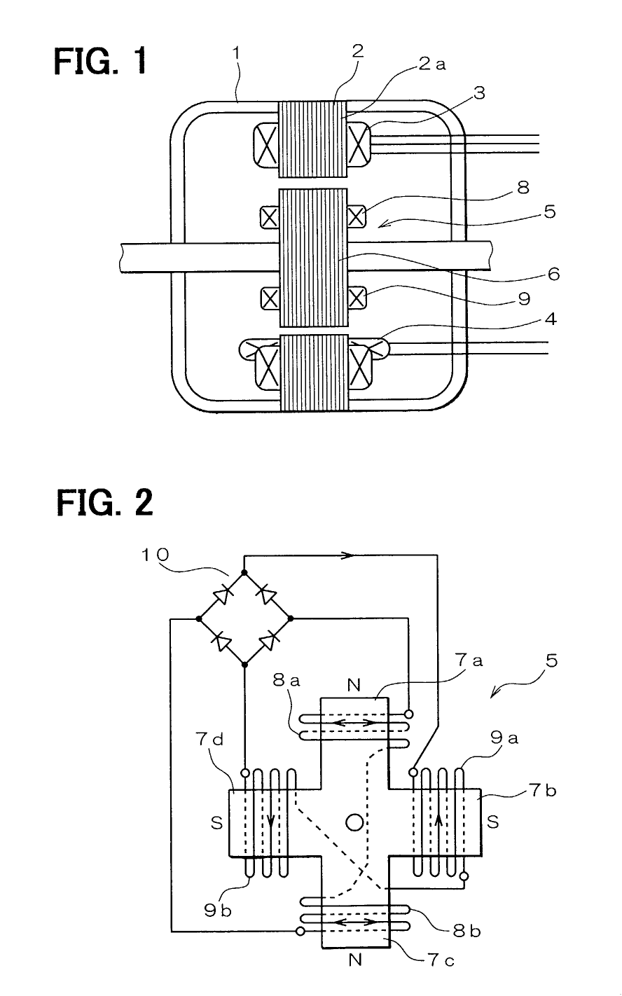

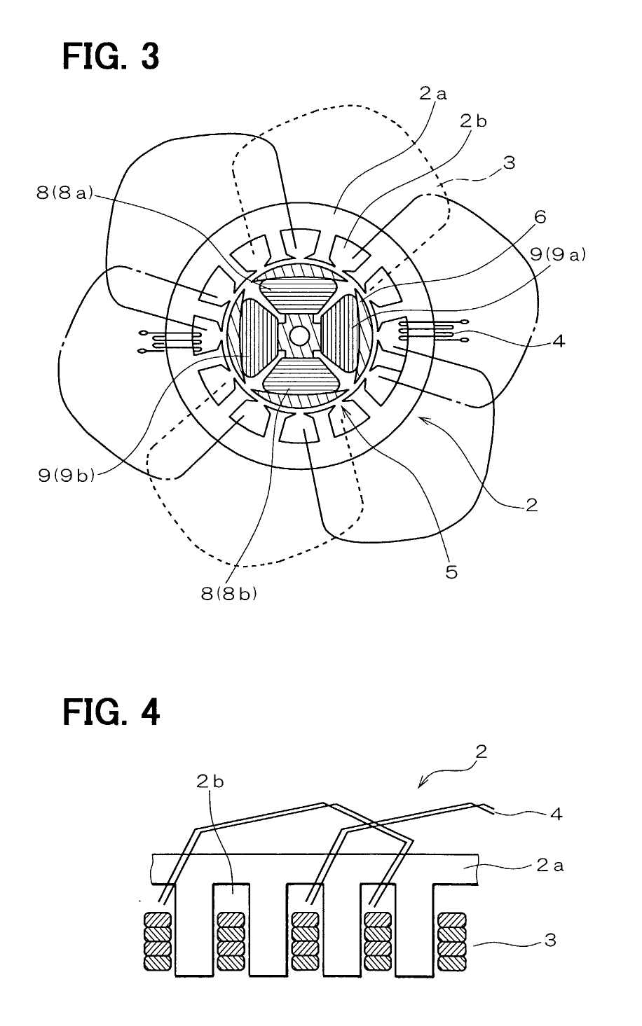

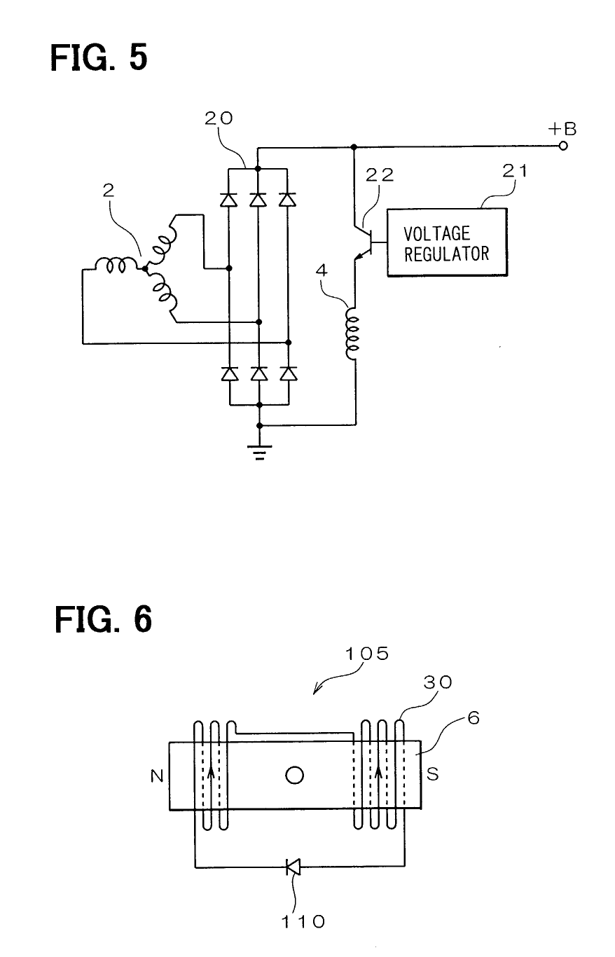

FIG. 1 is a view showing the basic construction of the first embodiment of the brushless generator. FIG. 2 is an explanatory view of a rotor included in the present embodiment of the brushless generator. FIG. 3 is an explanatory view of an armature included in the present embodiment of the brushless generator. FIG. 4 is an explanatory view showing details of an armature winding. And FIG. 5 is a connection diagram of the present embodiment of the brushless generator.

The brushless generator of the present embodiment shown in these views is comprised of a housing 1, an armature 2, a rotor 5, a three-phase full-wave rectifier 20, and a voltage regulator 21. The housing 1 is comprised of a lightweight, high-strength non-magnetic material (e.g., aluminum), fixedly securing the armature 2 and supporting the rotor 5 in a rotatable state.

The armature 2 is comprised of a laminated armature core 2a provided with a plurality of slots 2b formed in the inner periphery, a three-phase armature winding 3 as a polyphase winding wound on the laminated armature core 2a, and a control winding 4 as the magnetizing winding. The laminated armature core 2a has, for instance, 12 slots 2b, in which the three-phase armature winding 3 and the control winding 4 are wound with three slot pitches. The number of the series conductors of the control winding 4 as viewed from the output terminal of the brushless generator is set less than the number of series conductors of the three-phase armature winding 3. Furthermore, the control winding 4 is nonuniformly wound off balance in the circumferential direction of the laminated armature core 2a.

For example, the control winding 4 is formed so as to be of the same construction like the two- or single-phase winding included in the three-phase armature winding 3. The output terminal side of the three-phase armature winding 3 is connected to the three-phase full-wave rectifier 20, the positive and negative terminals of which are connected to the generator output terminal.

The rotor 5 is provided with a four-pole laminated field core 6, which uses three slots 2b formed in the laminated armature core 2a with one pole pitch. The four-pole laminated field core 6 forms the field pole including the first magnetic pole 7a, the second magnetic pole 7b, the first magnetic pole 7c, and the second magnetic pole 7d. Of these magnetic poles, the first magnetic poles 7a and 7c are wound with the first induction coil 8a and the second induction coil 8b, forming an induction winding 8. The second magnetic poles 7b and 7d are wound with the first excitation coil 9a and the second excitation coil 9b, forming a field winding 9.

For example, the number of turns of either of the first induction coil 8a or the second induction coil 8b is set at 20, while the number of turns of either of the first excitation coil 9a or the second excitation coil 9b is set at 200. Furthermore, the induction coil 8 is connected to the field winding 9 through a rotating rectifier 10 which constitutes a single-phase full-wave rectifier circuit.

The voltage regulator 21 functions to control the on and off state of a transistor 22 which serves as a switching element connected in series to the control winding 4. The collector of the transistor 22 is connected to the positive terminal of the three-phase full-wave rectifier 20, while the emitter is connected to the negative terminal of the three-phase full-wave rectifier 20 through the control winding 4. The amount of the direct current to be supplied to the control winding 4 is controlled by the on and off control of the transistor 22 by the voltage regulator 21.

The brushless generator of the present embodiment has the above-described construction. Its operation will be explained below.

As the direct current is supplied to the control winding 4, the laminated armature core 2a is magnetized with static magnetic flux. Accordingly, variable flux is supplied to the laminated field core 6 included in the rotor 5 which is rotating. With this flux variation, an induction electromotive force is produced in the induction winding 8 which comprises the first induction coil 8a and the second induction coil 8b. The induction electromotive force is rectified by the rotating rectifier 10. After rectification, the dc voltage is applied to both ends of the field winding 9 which is connected in series to the first excitation coil 9a and the second excitation coil 9b, thereby dc-energizing the field winding 9 to rotate the laminated field core 6 thus dc-energized. Thus the laminated armature core 2a receives the rotating field current, generating a great secondary electric power in the three-phase armature winding 3 wound on the laminated armature core 2a.

In general, the electric power generated in the three-phase armature winding 3 increases with an increase in excitation to the magnetic field in the case a great primary electric power is generated in the induction winding 8 stated above. Actually, however, self-impedance increases in case of a large number of turns of the induction winding 8, resulting in a decrease in the electric power to be generated. Therefore, in the brushless generator of the present embodiment, the number of turns of the induction winding 8 is set less than that of the field winding 9. Meanwhile, in the field winding 9, because dc voltage induced in the induction winding 8 is applied after rectification by the rotating rectifier 10, self-impedance proportional to the amount of resistance occurs if the winding has many turns of coils. Therefore, a relatively large number of turns is set for the field winding 9.

When a slight flux is given to the laminated field core 6 by the control winding 4, the electromotive force is induced in the induction winding 8 wound on the laminated field core 6, producing the electric force on the magnetic field side by the first generating operation. Subsequently, the electric force is obtained by the second generating operation of the armature 2 by exciting the magnetic field with the electric power thus generated. That is, by generating the electric power in two stages it is possible to gain a great amplification effect and accordingly great electrical energy. Furthermore, the exciting electric power is supplied by the operation of electromagnetic induction of the control winding 4 to the induction winding 8 provided on the laminated field core 6 side. According to this invention, therefore, a two-gap type magnetic circuit can be adopted while dispensing with the supply of the electric current through brushes used in conventional devices, thereby preventing a decrease in output.

In the brushless rotating electric machine of the present invention, the brushless configuration can be realized simply by providing the induction winding 8 and the rotating rectifier 10 on the laminated field core 6 side and the control winding 4 on the laminated armature core 2a side. Therefore, neither expensive components nor complicated control configurations are needed, enabling cost reduction. Also, by regulating the amount of current to be supplied to the control winding 4, it becomes possible to control the amount of current to be excited to the laminated field core 6 by the induction winding 8, thus facilitating the control of the output voltage and the amount of power generated by the brushless generator.

In the case in which the control winding 4 is wound on the laminated armature core with the same pitch as the three-phase armature winding 3, the induction voltage is produced also in the control winding 4 with the rotation of the rotor 5. Since the number of series conductors of the control winding 4 is set less than that of the three-phase armature winding 3, the induction voltage of the control winding 4 can always be set lower than that of the three-phase armature winding 3. Therefore, the current supply control relative to the control winding 4 can easily be performed by means of the voltage regulator 21.

Furthermore, as compared with the case of when a solid field core is employed, the use of the laminated field core 6 has such an advantage as to easily provide flux variation to the magnetic field from the control winding 4.

[Second Embodiment]

In the first embodiment described above, the induction winding 8 and the field winding 9 are separately provided. In the second embodiment, however, the induction winding 8 may be used to serve also as the field winding 9.

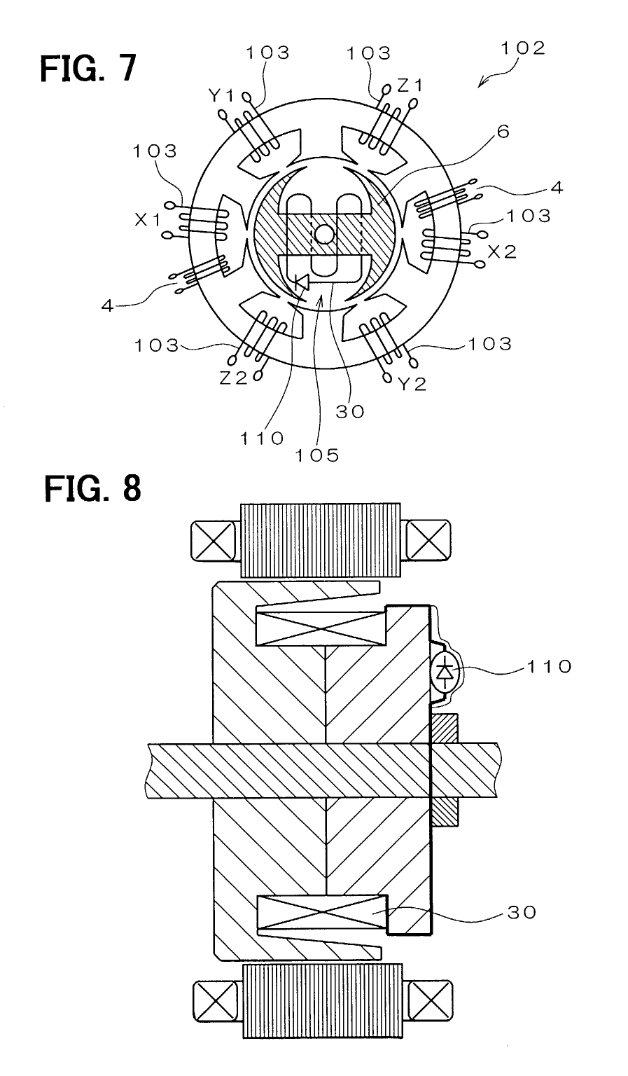

FIG. 6 is an explanatory view of the rotor included in the second embodiment of the brushless generator. FIG. 7 is an explanatory view of the armature included in the present embodiment of the brushless generator.

As shown in these drawings, a rotor 105 included in the present embodiment of the brushless generator has an induction field winding 30 wound on the laminated field core 6 and a rotating rectifier 110 short-circuited at both ends of the induction field winding 30. The rotating rectifier 110 is composed of, for example, one diode. The number of turns of the induction field winding 30 is set less than that of the field winding 9 used in the first embodiment, for the purpose of reducing the self-inductance with a function as the induction winding taken into consideration, and both functions of generation and excitation of the induction voltage are optimized.

Furthermore, in the present embodiment, the number of poles of the rotor 105 is set to two, as shown in FIG. 7, for the purpose of decreasing the power generation frequency. To reduce the amount of copper, the three-phase armature winding 103 is toroidally wound on the core back portion of the armature 102. FIG. 7 shows the formation of the X phase in which the X1 winding and the X2 winding are mutually connected in series so as to be in the same phase, the Y phase in which the Y1 winding and the Y2 winding are mutually connected in series so as to be in the same phase, and the Z phase in which the Z1 winding and the Z2 winding are mutually connected in series so as to be in the same phase. Also, since one induction field winding 30 is employed in the present embodiment, the Landelle rotor shown in FIG. 8 may be adopted.

While preferred embodiments of this invention are shown and described above, it will be understood that the invention is not to be limited thereto, since many modifications and changes may be made therein without departing from the scope of the invention. In each of the embodiments described above, either of the three-phase armature windings 3 and 103 is separately provided with the control winding 4. The control winding 4 may be configured by the use of a part of the three-phase windings 3 and 103. For example, there may be such a case that the phase of either the three-phase armature winding 3 or 103 in Y connection will be used also as the control winding 4. Because of this configuration, it becomes possible to decrease component count and installation time, thereby enabling a cost reduction.

According to the first embodiment described above, the rotating rectifier 10 is constructed of the full-wave rectifier circuit. In this case, a half-wave rectifier circuit and other circuits which are able to rectify the alternating current induction voltage to the direct current may be adopted.

Furthermore, in each of the embodiments described above, the direct current is supplied to the control winding 4. In this case, however, the ac current may be supplied in place of the direct current where it is possible to change the interlinkage flux which passes through the induction winding 8 and the induction field winding 30.

Furthermore, in each of the embodiments described above, the electric current is supplied from outside of the armature 2 or 102 into the control winding 4. After starting generation, the induction voltage is generated in the control winding 4 itself. Therefore, flux pulsation may be produced in the magnetic field by short-circuiting both ends of the control winding 4 in which the induction voltage is generated. That is, it is advised to give a pulsation field to the laminated field core 6 by providing a means which disturbs the three-phase symmetry of the armatures 2 and 102.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A brushless rotating electric machine, comprising:
an armature having a polyphase winding on an armature core;
a field core wound with a field winding;
a first exciting means which provides flux variation to the field core; and
a second exciting means which supplies direct current to the field winding by utilizing the flux variation provided as an exciting source to the field core by the first exciting means.

2. The brushless rotating electric machine according to claim 1, wherein the first exciting means is an exciting winding wound on the armature core to supply the direct current, and the second exciting means comprises an induction winding provided on the field core and a rectifier connected to the induction winding.

3. The brushless rotating electric machine according to claim 2, wherein the induction winding serves also as the field winding, and short-circuits the field winding through the rectifier.

4. The brushless rotating electric machine according to claim 2, wherein the armature winding and the exciting winding are wound with the same pitch in a plurality of slots formed in the armature core.

5. The brushless rotating electric machine according to claim 4, wherein the number of series conductors of the exciting winding is less than that of the polyphase winding.

6. The brushless rotating electric machine according to claim 4, wherein the exciting winding is constituted by use of a part of the armature winding.
